(19) United States
(12) Patent Application Publication
(10) Pub. No.: US 2026/0104787 A1
(43) Pub. Date: Apr. 16, 2026

(54) ELECTRONIC APPARATUS AND CONTROL METHOD THEREOF

(71) Applicant: Samsung Electronics Co., Ltd., Suwon-si (KR)

(72) Inventors: Sangyoon LEE, Suwon-si (KR); Jingun JUNG, Suwon-si (KR); Soyoung YUN, Suwon-si (KR)

(21) Appl. No.: 19/414,613

(22) Filed: Dec. 10, 2025

Related U.S. Application Data
(63) Continuation of application No. PCT/KR2025/010826, filed on Jul. 22, 2025.

(30) Foreign Application Priority Data
Oct. 16, 2024 (KR) 10-2024-0141380

(51) Int. Cl. G06F 3/04842; G06F 3/04817; G06F 3/0488

(52) U.S. Cl. CPC G06F 3/04842; G06F 3/04817; G06F 3/0488; G06F 2203/04803

(57) ABSTRACT

An electronic apparatus includes a memory configured to store at least one instruction, a communication device configured to perform communication with an external electronic apparatus, and at least one processor configured to be connected to the memory and the communication device to control the electronic apparatus. The at least one processor is configured to obtain at least one image of interest from among a plurality of images included in content played by the electronic apparatus based on a first user manipulation input received from the external electronic apparatus, obtain at least one search result corresponding to an object that is a search target among at least one object included in the at least one image of interest, and obtain a multi-view image including the at least one image of interest, the at least one search result, and the content being played.

### CROSS-REFERENCE TO RELATED APPLICATIONS

This application is a continuation application of International Application No. PCT/KR2025/010826, filed on July 22, 2025, which is based on and claims the priority to Korean Patent Application No. 10-2024-0141380, filed on October 16, 2024, in the Korean Intellectual Property Office, the disclosures of which are incorporated by reference herein in their entireties.

### BACKGROUND

### Field

Apparatuses and methods consistent with the disclosure relate to an electronic apparatus and a control method thereof, and more particularly, to an electronic apparatus for obtaining a search result from content being played on the electronic apparatus and obtaining a multi-view image including the search result, and a control method thereof.

### DESCRIPTION OF RELATED ART

With the development of electronic technology, the use of electronic products that may provide information related to content while playing the content on a screen is increasing.

In particular, recently, the electronic products that may automatically search for an object included in a specific scene of a video while playing the video such as a movie or a drama and provide the search result together is being developed.

### SUMMARY

In accordance with an aspect of the disclosure, an electronic apparatus includes a memory configured to store at least one instruction, a communication device configured to perform communication with an external electronic apparatus, and at least one processor configured to be connected to the memory and the communication device to control the electronic apparatus. The at least one processor is configured to obtain at least one image of interest from among a plurality of images included in a content played by the electronic apparatus, based on a first user manipulation input received from the external electronic apparatus; obtain at least one search result corresponding to an object that is a search target among at least one object included in the at least one image of interest; and obtain a multi-view image including the at least one image of interest, the at least one search result, and the content being played.

The first user manipulation input may be an input for capturing an image included in the content, and the at least one processor may be configured to capture the at least one image of interest from among the plurality of images based on the first user manipulation input, to obtain the at least one image of interest.

The first user manipulation input may include information on at least one object of interest, and the at least one processor may be configured to obtain the at least one image of interest including the at least one object of interest among the plurality of images based on the information.

The memory may be configured to store a neural network model trained to recognize an object included in an input image, and the at least one processor may be configured to input the ta least one image of interest to the neural network model to obtain at least one object included in the at least one image of interest, and obtain at least one search result corresponding to an object that is the search target among the obtained at least one object.

The at least one processor may be configured to obtain at least one user interface (UI) including each of the obtained at least one object, obtain at least one search result corresponding to the object that is the search target among the at least one object upon receiving a second user manipulation input for selecting the search target among the at obtained least one object, and obtain the multi-view image including at least one image of interest on which the at least one UI is displayed, the at least one search result, and the content being played.

The at least one processor may be configured to obtain at least one search result corresponding to the object that is the search target upon receiving a third user manipulation input for selecting, as the search target, at least one object included in the at least one image of interest from the external electronic apparatus.

The third user manipulation input may correspond to a touch input that is input to the external electronic apparatus for selecting the at least one object as the search target, and the at least one processor may be configured to obtain a trajectory corresponding to the touch input upon receiving the third user manipulation input and obtain at least one search result corresponding to at least one object included in an area defined by the trajectory among the at least one image of interest.

The at least one processor may be configured to obtain the at least one search result classified according to a plurality of information types, and the plurality of information types may include at least one of a shopping list, a review, and a video content.

The memory may be configure to store a neural network model trained to output arrangement information of a plurality of search results based on personal information on a user of the electronic apparatus, and the at least one processor may be configured to obtain the at least one search result based on the arrangement information acquired by inputting the at least one search result and the personal information to the neural network model.

The electronic apparatus may further include a display, and the at least one processor may be configured to control the display to display the at least one image of interest, the at least one search result, and the content being played in each of a plurality of partial areas of the multi-view image during a search mode for searching for at least one object included in the at least one image of interest, control the display to display the content being played in an entire region based on a fourth user manipulation input for switching from the search mode to a reproduction mode being received, and control the communication device to provide at least one of the at least one search result and the at least one image of interest to the external electronic apparatus.

In accordance with another aspect of the disclosure, a control method of an electronic apparatus includes obtaining at least one image of interest from among a plurality of images included in a content played by the electronic apparatus, based on a first user manipulation input received from the external electronic apparatus; obtaining at least one search result corresponding to an object that is a search target among at least one object included in the at least one image of interest; and obtaining a multi-view image including the at least one image of interest, the at least one search result, and the content being played.

The first user manipulation input may be an input for capturing an image included in the content, and the obtaining the at least one image of interest may include capturing the at least one image of interest from among the plurality of images based on the first user manipulation input, to obtain the at least one image of interest.

The first user manipulation input includes information on at least one object of interest, and the obtaining the at least one image of interest may include obtaining the at least one image of interest including the at least one object of interest among the plurality of images based on the information.

The obtaining the at least one search result may include obtaining at least one object included in the at least one image of interest by inputting the image of interest to a neural network model, and obtaining at least one search result corresponding to an object that is the search target among the obtained at least one object, and the neural network model may be a model trained to recognize an object included in an input image.

The obtaining the at least one search result may include obtaining at least one user interface (UI) including each of the obtained at least one object, obtaining at least one search result corresponding to the object that is the search target, upon receiving a second user manipulation input for selecting the search target among the obtained at least one object, and the obtaining the multi-view image may include obtaining the multi-view image including at least one image of interest on which the at least one UI is displayed, the at least one search result, and the content being played.

The obtaining the at least one search result may include receiving a third user manipulation input for selecting, as the search target, one of the at least one object included in the at least one image of interest from the external electronic apparatus, and obtaining at least one search result corresponding to the object that is the search target.

The third user manipulation input may correspond to the touch input, which is input to the external electronic apparatus, for selecting the at least one object as the search target, and the obtaining the at least one search result may include obtaining a trajectory corresponding to the touch input upon receiving the third user manipulation input, and obtaining at least one search result corresponding to at least one object included in an area defined by the trajectory among the at least one image of interest.

The obtaining the at least one search result may include obtaining the at least one search result classified according to a plurality of information types, and the plurality of information types may include at least one of a shopping list, a review, and a video content.

The obtaining the at least one search result may include obtaining at least one search result based on the arrangement information obtained by inputting the at least one search result and personal information to a neural network model, and the neural network model may be a model trained to output arrangement information of a plurality of search results based on the personal information on the user of the electronic apparatus.

In accordance with still another aspect of the disclosure, there is provided a non-transitory computer-readable recording medium storing a computer command that, when executed by a processor of an electronic apparatus, causes the electronic apparatus to perform obtaining at least one image of interest from among a plurality of images included in a content played by the electronic apparatus, based on a first user manipulation input received from the external electronic apparatus; obtaining at least one search result corresponding to an object that is a search target among at least one object included in the at least one image of interest; and obtaining a multi-view image including the at least one image of interest, the at least one search result, and the content being played.

### BRIEF DESCRIPTION OF DRAWINGS

The above and other aspects and features of the disclosure will become more apparent by describing in detail example embodiments thereof with reference to the attached drawings.

FIG. 1 is a diagram for describing operations of an electronic apparatus and an external electronic apparatus according to one or more embodiments of the disclosure.

FIG. 2 is a block diagram for describing a configuration of an electronic apparatus according to one or more embodiments of the disclosure.

FIG. 3 is a block diagram for describing a configuration of an external electronic apparatus according to one or more embodiments of the disclosure.

FIG. 4 is a diagram for describing an operation of an electronic apparatus according to one or more embodiments of the disclosure.

FIG. 5 is a diagram for describing a multi-view according to one or more embodiments of the disclosure.

FIG. 6 is a diagram for describing an operation of capturing an image of interest according to one or more embodiments of the disclosure.

FIG. 7 is a diagram for describing an operation of capturing an image of interest according to one or more embodiments of the disclosure.

FIG. 8 is a diagram for describing an operation of capturing an image of interest according to one or more embodiments of the disclosure.

FIG. 9 is a diagram for describing an image of interest including an object of interest according to one or more embodiments of the disclosure.

FIG. 10 is a diagram for describing a selectable object according to one or more embodiments of the disclosure.

FIG. 11 is a diagram for describing a trajectory according to one or more embodiments of the disclosure.

FIG. 12 is a diagram for describing related content according to one or more embodiments of the disclosure.

FIG. 13 is a diagram for describing related content according to one or more embodiments of the disclosure.

FIG. 14 is a diagram for describing a search result according to one or more embodiments of the disclosure.

FIG. 15 is a flowchart for describing a control method of an electronic apparatus according to one or more embodiments of the disclosure.

### DETAILED DESCRIPTION

Since the disclosure may be variously modified and have several example embodiments, specific example embodiments of the disclosure will be illustrated in the drawings and be described in detail in the detailed description. However, it is to be understood that the disclosure is not limited to specific example embodiments, but include all modifications, equivalents, and substitutions according to example embodiments of the disclosure. Throughout the accompanying drawings, similar components will be denoted by similar reference numerals.

In describing the disclosure, when it is decided that a detailed description for the known functions or configurations related to the disclosure may unnecessarily obscure the gist of the disclosure, the detailed description therefor will be omitted.

In addition, the following example embodiments may be modified in several different forms, and the scope and spirit of the disclosure are not limited to the following example embodiments. Rather, these example embodiments make the disclosure thorough and complete, and are provided to completely transfer the spirit of the disclosure to those skilled in the art.

Terms used in the disclosure are used only to describe specific example embodiments rather than limiting the scope of the disclosure. Singular expressions are intended to include plural expressions unless the context clearly indicates otherwise.

In the disclosure, an expression “have,” “may have,” “include,” “may include,” or the like, indicates existence of a corresponding feature (for example, a numerical value, a function, an operation, a component such as a part, or the like), and does not exclude existence of an additional feature.

In the disclosure, an expression “A or B,” “at least one of A and/or B,” “one or more of A and/or B,” or the like, may include all possible combinations of items enumerated together. For example, “A or B,” “at least one of A and B,” or “at least one of A or B” may indicate all of 1) a case in which at least one A is included, 2) a case in which at least one B is included, or 3) a case in which both of at least one A and at least one B are included.

Expressions “first,” “second,” “1st" or "2nd" or the like, used in the disclosure may indicate various components regardless of a sequence and/or importance of the components, will be used only in order to distinguish one component from the other components, and do not limit the corresponding components.

When it is mentioned that any component (for example: a first component) is (operatively or communicatively) coupled with/to or is connected to another component (for example: a second component), it is to be understood that any component is directly coupled to another component or may be coupled to another component through the other component (for example: a third component).

On the other hand, when it is mentioned that any component (for example, a first component) is “directly coupled” or “directly connected” to another component (for example, a second component), it is to be understood that the other component (for example, a third component) is not present between any component and another component.

An expression “~configured (or set) to” used in the disclosure may be replaced by an expression “suitable for,” “having the capacity to,” “~designed to,” “~adapted to,” “~made to,” or “~capable of” depending on a situation. A term “~configured (or set) to” may not necessarily mean “specifically designed to” in hardware.

Instead, an expression “~an apparatus configured to” may mean that the apparatus "is capable of” together with other apparatuses or components. For example, a “processor configured (or set) to perform A, B, and C” may mean a dedicated processor (for example, an embedded processor) for performing the corresponding operations or a generic-purpose processor (for example, a central processing unit (CPU) or an application processor) that may perform the corresponding operations by executing one or more software programs stored in a memory apparatus.

In example embodiments, a “module” or a “unit” may perform at least one function or operation, and be implemented by hardware or software or be implemented by a combination of hardware and software. In addition, a plurality of “modules” or a plurality of “units” may be integrated in at least one module and be implemented by at least one processor except for a “module” or a “unit” that needs to be implemented by specific hardware.

Various elements and regions in the drawings are schematically illustrated. Therefore, the spirit of the disclosure is not limited by relatively sizes or intervals illustrated in the accompanying drawings.

Hereinafter, embodiments of the disclosure will be described in detail with reference to the accompanying drawings so that those skilled in the art to which the disclosure pertains may easily practice the disclosure.

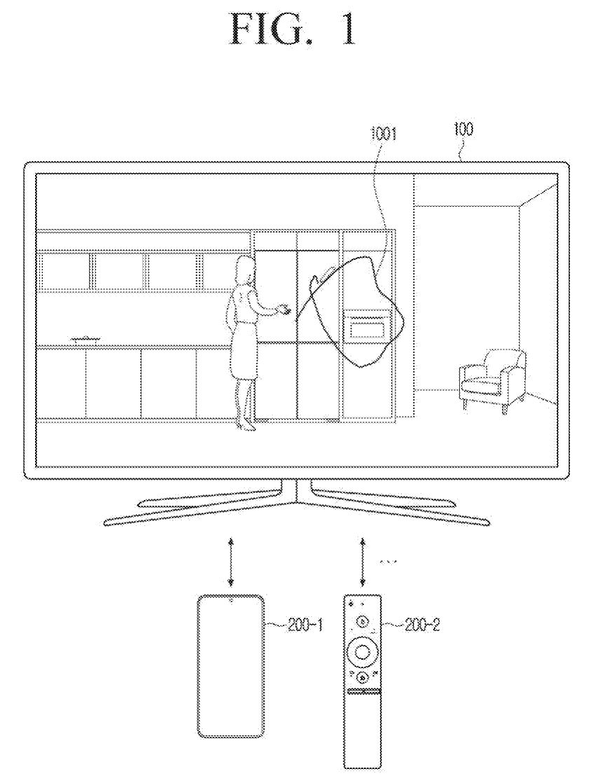

FIG. 1 is a diagram for describing operations of an electronic apparatus and an external electronic apparatus according to one or more embodiments of the disclosure.

Referring to FIG. 1, an electronic apparatus 100 and an external electronic apparatus are illustrated. The electronic apparatus 100 may be connected to external electronic apparatuses 200-1, 200-2, ... to display a screen.

Here, the electronic apparatus 100 may be implemented as at least one of a smartphone, a tablet personal computer (PC), a desktop PC, a laptop PC, a PC, a set-top box, an over-the-top media service (OTT service) server, a console (video game console), a Blu-ray player, a digital video disc or digital versatile disc (DVD) player, a home automation control panel, a security control panel, a media box (e.g., Samsung HomeSyncTM, AppleTVTM, or Google TVTM), and a game console (e.g., XboxTM, PlayStationTM). However, the electronic apparatus 100 is not limited thereto.

For example, when the electronic apparatus 100 is implemented as the set-top box, the electronic apparatus 100 may receive content from an external source. The electronic apparatus 100 may provide the received content to the external display apparatus equipped with a display. Here, the electronic apparatus 100 may output a screen of content received from the external source.

Here, the electronic apparatus 100 may not only play the content of the electronic apparatus 100, but also obtain information related to the content. For example, the information related to the content may correspond to the information related to the content itself, such as a content creator, a production year, and a genre. However, the content information is not limited thereto, and may correspond to linked content, online search results related to the content, etc.

Here, the search result may correspond to information provided when a search is performed on an object included in a specific scene while using the electronic apparatus 100. For example, the search result may include detailed information on an object, related images, a recommendation for a similar product, etc.

Here, the detailed information may include a website link for purchasing a corresponding object, and the detailed information may include various types of information that may be obtained through websites, such as a size and a weight of the corresponding object.

Here, the similar product may refer to a product that has a similar appearance and/or functionality to the corresponding object. Alternatively, the similar product may refer to an item manufactured by the same manufacturer of the corresponding object. Alternatively, the similar product may include an item that has a size similar to the size of the corresponding object.

Accordingly, the electronic apparatus 100 may provide the obtained related information to the external display apparatus, etc. The external display apparatus may display the information provided from the electronic apparatus 100 on a screen.

When the electronic apparatus 100 is implemented as a display apparatus (e.g., a smartphone, tablet, TV, etc.) equipped with a display, the image included in the content may be output through the display. Here, the content may include at least one of a text, an image, and a video that are received from an external content source and/or pre-stored in the electronic apparatus 100. In this case, the electronic apparatus 100 may display the content and the related information together on the screen.

The external electronic apparatuses 200-1, 200-2, ... may communicate with the electronic apparatus 100. The external electronic apparatuses 200-1, 200-2, ... may provide data (e.g., media content) used in an operation of the electronic apparatus 100 and/or provide signals capable of controlling the operation of the electronic apparatus 100. Here, the external electronic apparatuses 200-1, 200-2, ... may be implemented as a smartphone, a PC, etc., similar to the electronic apparatus 100 described above.

As an example, the external electronic apparatuses 200-1, 200-2, ... may provide various control signals to the electronic apparatus 100. For example, the external electronic apparatuses 200-1, 200-2, ... may provide a control signal for capturing a screen of content played by the electronic apparatus 100. Additionally and/or alternatively, the external electronic apparatuses 200-1, 200-2, ... may provide a control signal for searching for the captured screen. However, the external apparatuses 200-1, 200-2, … are not limited thereto, and may provide a signal for controlling (e.g., play, pause, fast forward, etc.) playback of the content being played and may provide a control signal for receiving a search result, etc., obtained by the electronic apparatus 100.

When the external electronic apparatuses 200-1, 200-2, ... are implemented as a user terminal apparatus 200-1 such as a smartphone, the user terminal apparatus 200-1 may receive a user's touch input (e.g., input to define an area 1001 on an image displayed on the screen of the electronic apparatus 100) through a touch display, etc. The user terminal apparatus 200-1 may provide a control signal corresponding to the user’s touch input to the electronic apparatus 100.

Additionally and/or alternatively to the examples described above, the external electronic apparatuses 200-1, 200-2, ... may be implemented as a remote control 200-2, etc., which may control the operation of the electronic apparatus 100. Here, the remote control 200-2 may be a wireless apparatus that allows remote control of the electronic apparatus 100 such as a TV or an audio apparatus. In this case, the remote control 200-2 may transmit, to the electronic apparatus 100, a signal received through a button on the remote control 2002-2 to operate various functions of the electronic apparatus 100.

Here, the remote control 200-2 may include a remote control 200-2 equipped with a gyro sensor. Here, the gyro sensor may also be referred to as a gyroscope sensor. The gyroscope sensor may correspond to an apparatus that detects and measures a rotational movement of an object. When the remote control 200-2 is equipped with the gyro sensor, the remote control 200-2 may detect the rotational movement of the remote control 200-2, etc., and transmit a signal corresponding to the rotational movement to the electronic apparatus 100.

Even if the external electronic apparatuses 200-1 and 200-2 are implemented as the user terminal apparatus 200-1 such as a smartphone, the external electronic apparatuses 200-1 and 200-2 may perform the function of the remote control 200-2 as described above. For example, the operation of the electronic apparatus 100 may be controlled through an application installed in the user terminal apparatus 200-1. Here, the application may include a command for transmitting a control signal to the electronic apparatus 100 through the user terminal apparatus 200-1.

Although FIG. 1 illustrates that the external electronic apparatuses 200-1 and 200-2 are respectively implemented as the user terminal apparatus 200-1 such as the smartphone and the remote control 200-2, the external electronic apparatuses 200-1, 200-2, ... are not limited thereto, and may be implemented as various types of apparatuses that may control the operation of the electronic apparatus 100.

As described above, the electronic apparatus 100 may perform various functions by receiving control signals provided by the external electronic apparatuses 200-1, 200-2, .... The electronic apparatus 100 may acquire information related to content being played while playing the content. The electronic apparatus 100 may acquire an image to provide the obtained information while continuously playing the content.

Here, the image may correspond to a multi-view screen in which a content playback screen and content-related information are displayed together. An image of the multi-view screen (or multi-view image) may correspond to an image that simultaneously displays multiple visual content and/or images on one screen. The multi-view image may efficiently deliver information by simultaneously providing various information and/or visual experiences to the user.

For example, the electronic apparatus 100 may acquire a multi-view image that may provide search content for an item appearing in the content as well as the content being played. The obtained multi-view image may be provided through the screen equipped in the electronic apparatus 100 and may be provided to the external display apparatuses (TV, smartphone, tablet, etc.).

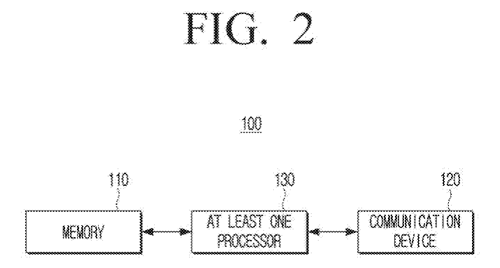

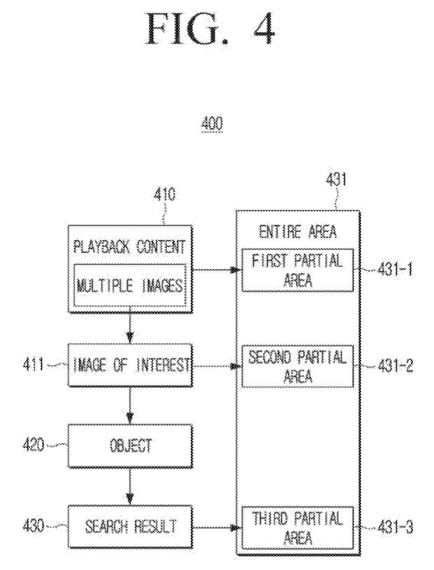

Specific operation steps for obtaining the multi-view image by the electronic apparatus 100 will be specifically described with reference to FIGS. 2 and 4 described below.

FIG. 2 is a block diagram for describing a configuration of the electronic apparatus according to one or more embodiments of the disclosure.

Referring to FIG. 2, the electronic apparatus 100 may include a memory 110, a communication device 120, and at least one processor 130.

The memory 110 is electrically connected to the at least one processor 130 and may store data related to various embodiments of the disclosure. For example, the memory 110 may be implemented as an internal memory such as a read-only memory (ROM) (e.g., an electrically erasable programmable read-only memory (EEPROM)), and a random access memory (RAM) included in the at least one processor 130, or may be implemented as a separate memory from the at least one processor 130.

The memory 110 may be implemented in a form of a memory embedded in the electronic apparatus 100 or a form of a memory attachable to and detachable from the electronic apparatus 100, depending on a data storing purpose. For example, data for driving the electronic apparatus 100 may be stored in the memory embedded in the electronic apparatus 100, and data for an extension function of the electronic apparatus 100 may be stored in the memory attachable to and detachable from the electronic apparatus 100. When implemented as a memory embedded in the electronic apparatus 100, the memory 110 may be at least one of a volatile memory (for example, a dynamic random access memory (DRAM), a static RAM (SRAM), a synchronous dynamic RAM (SDRAM), or the like), a non-volatile memory (for example, a one time programmable read only memory (OTPROM), a programmable ROM (PROM), an erasable and programmable ROM (EPROM), an electrically erasable and programmable ROM (EEPROM), a mask ROM, a flash ROM, or the like), a flash memory (for example, a NAND flash, a NOR flash, or the like), a hard drive, and a solid state drive (SSD)).

In the illustrated example, the electronic apparatus 100 is illustrated as including one memory, but the disclosure is not limited thereto. When referring to volatile memory and non-volatile memory separately, the electronic apparatus 100 may be referred to as including multiple memories.

The memory 110 according to an embodiment may store at least one instruction. Here, at least one instruction may correspond to at least one instruction for the electronic apparatus 100 to obtain the multi-view image. In addition, the memory 110 may store information related to the operation of the electronic apparatus 100.

The memory 110 according to one or more embodiments may store at least one neural network model. Here, the neural network model may be a computer system and/or software module for implementing human-level intelligence, and allows a machine to learn by itself and make a judgment on its own. A recognition rate of the neural network model is improved as the neural network model is more used.

The neural network model is based on machine learning (e.g., deep learning) technology that uses an algorithm that classifies and/or trains characteristics of input data on its own, and element technologies that simulate the functions of a human brain, such as cognition and judgment, by utilizing a machine learning algorithm.

Here, the neural network model may be referred to as a learning model, an artificial intelligence (AI) model, a deep learning model, etc.

Examples of the element technologies may include at least one of linguistic understanding technology for recognizing human language/character, visual understanding technology for recognizing objects like human vision, reasoning/prediction technology for logically reasoning and predicting information by determining the information, or knowledge expression technology processing human experience information with knowledge data.

The neural network model may correspond to a generative artificial intelligence (generative AI) model. Here, the generative AI is an AI system that focuses on generating new data, and may perform a role of training patterns of given data and generating similar or completely new data. The generative AI may be distinguished from general AI that aims to interpret data and recognize patterns.

For example, the neural network model may correspond to a model that is trained to input an image included in content and output an image of interest suitable for a user. Here, the image of interest suitable for the user may mean an image that is estimated to be preferred by the user based on user's profile information (e.g., age, gender, viewing history, etc.) and viewing characteristics (e.g., preferred genre, main viewing time zone, etc.).

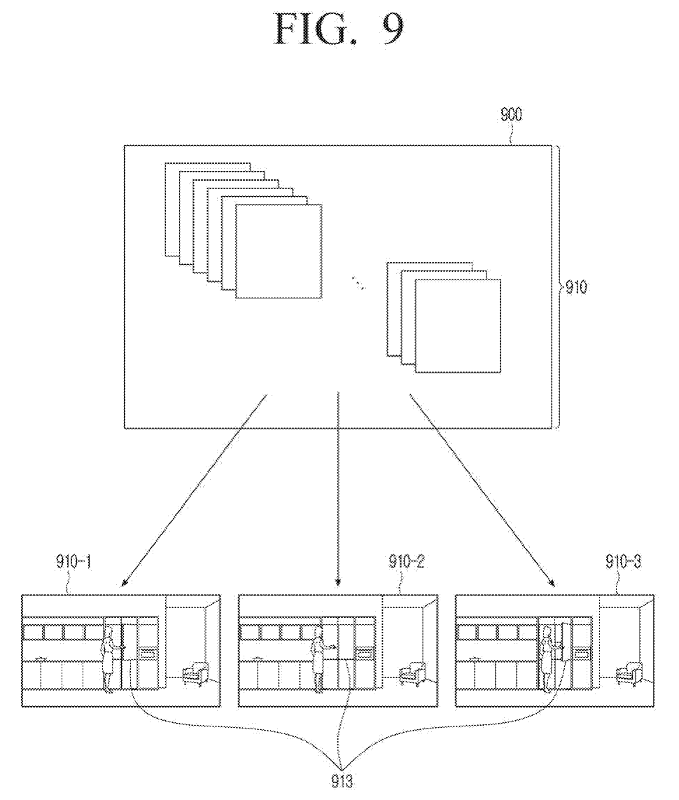

For example, the neural network model may correspond to an object recognition model that recognizes an object included in an image. In an example, the user may set a specific type of an object as an object of interest, and the neural network model may correspond to a model trained to identify and output an image including the object of interest. Alternatively, the object recognition model may correspond to a model trained to recognize at least one object included in the image of interest. Here, an example of the object of interest will be described in FIG. 9.

The neural network model is not limited to the above-described examples, and the neural network model may be implemented as various models trained to perform operations of the electronic apparatus 100 to obtain the multi-view image.

The communication device 120 is a component for performing communication with various types of external apparatuses depending on various types of communication manners. The communication device 120 may include a wireless fidelity (WiFi) module, a Bluetooth module, an infrared communication module, a wireless communication module, and the like. Here, each communication module may be implemented in a form of at least one hardware chip.

The Wi-Fi module and the Bluetooth module may perform communication in a Wi-Fi manner and a Bluetooth manner, respectively. In the case of using the Wi-Fi module or the Bluetooth module, various connection information such as a service set identifier (SSID), a session key, and the like, may be first transmitted and received, communication may be connected using the connection information, and various information may then be transmitted and received.

The infrared communication module may perform communication according to an infrared data association (IrDA) technology of wirelessly transmitting data to a short distance using an infrared ray positioned between a visible ray and a millimeter wave.

The wireless communication module may include at least one communication chip configured to perform communication according to various wireless communication standards such as zigbee, 3rd generation (3G), 3rd generation partnership project (3GPP), long term evolution (LTE), LTE advanced (LTE-A), 4th generation (4G), 5th generation (5G), and the like, in addition to the communication manner described above.

In addition, the communication device 120 may include at least one of wired communication modules that perform communication using a local area network (LAN) module, an Ethernet module, a pair cable, a coaxial cable, an optical fiber cable, an ultra wide-band (UWB) module, etc. Such a communication device 120 may also be referred to as a transceiver.

According to one or more embodiments, the electronic apparatus 100 may perform communication with the external electronic apparatus (the user terminal apparatus, the remote control, etc.) through the communication device 120. For example, the electronic apparatus 100 may receive various types of a user manipulation input from the external electronic apparatus. For example, the user manipulation input may correspond to a signal for obtaining an image of interest among multiple images included in the content. Alternatively, the user manipulation input may correspond to a signal for obtaining at least one search target.

For example, here, the user manipulation input may correspond to a remote control signal received through the communication device 120. Alternatively, the user manipulation input may correspond to a manipulation signal corresponding to a touch input that is input to the external electronic apparatus.

The electronic apparatus 100 may provide the multi-view image, the search result, etc., to an external apparatus through the communication device 120. Here, the external apparatus may correspond to a display apparatus (TV, smartphone, tablet PC, etc.) for displaying the multi-view image or the search result. However, the external apparatus is not limited thereto.

The at least one processor 130 may perform an overall control operation of the electronic apparatus 100.

The at least one processor 130 may be implemented by, for example, a digital signal processor (DSP), a microprocessor, or a time controller (TCON) that processes a digital signal. However, the at least one processor 130 is not limited thereto, but may include one or more of a central processing unit (CPU), a micro controller unit (MCU), a micro processing unit (MPU), a controller, an application processor (AP), a graphics-processing unit (GPU), a communication processor (CP), and an ARM processor, or may be defined by these terms. In addition, the at least one processor 130 may be implemented by a system-on-chip (SoC) or a large scale integration (LSI) in which a processing algorithm is embedded, or may be implemented in a field programmable gate array (FPGA) form. In addition, the at least one processor 130 may perform various functions by executing computer executable instructions stored in the memory 110. While FIG. 2 illustrates that the at least one processor 130 is included in the electronic apparatus 100, the at least one processor 130 may include multiple processors (e.g., CPU + GPU, CPU + DSP).

According to one or more embodiments, the at least one processor 130 may obtain at least one image of interest from among multiple images included in content played by the electronic apparatus 100 based on a first user manipulation input received from an external electronic apparatus 200-1, 200-2, etc..

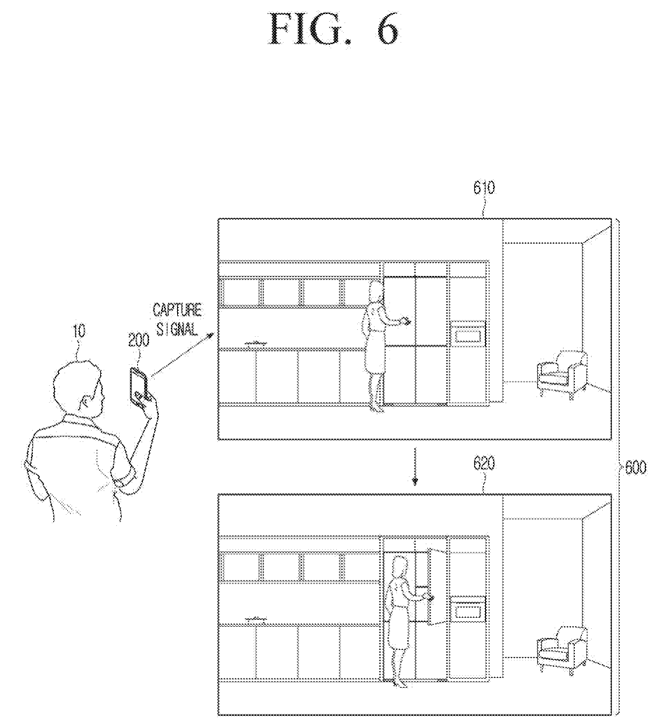

For example, the at least one processor 130 may capture at least one image of interest from among multiple images based on the first user manipulation input to obtain at least one image of interest. Here, the first user manipulation input may correspond to a manipulation for capturing an image included in the content. This will be described in detail later with reference to FIGS. 6, 7, and 8.

For example, the first user manipulation input may correspond to an input for capturing and saving a screen currently being played among videos played by the electronic apparatus 100. In this case, the user manipulation input may correspond to a signal corresponding to a remote control signal provided by the external electronic apparatus or a touch signal input to the external electronic apparatus.

For example, the at least one processor 130 may be configured to obtain at least one image of interest including the at least one object of interest among the plurality of images based on information on the at least one object of interest included in the first user manipulation input. This will be described in detail later with reference to FIG. 9.

According to one or more embodiments, the at least one processor 130 may obtain at least one search result corresponding to one object that is a search target among at least one object included in at least one image of interest.

For example, the at least one processor 130 may input an image of interest to a neural network model to obtain at least one object included in at least one image of interest. Here, the neural network model may correspond to a neural network model trained to recognize an object included in an input image.

Thereafter, the at least one processor 130 may obtain at least one search result corresponding to one object that is the search target among the at least one object obtained.

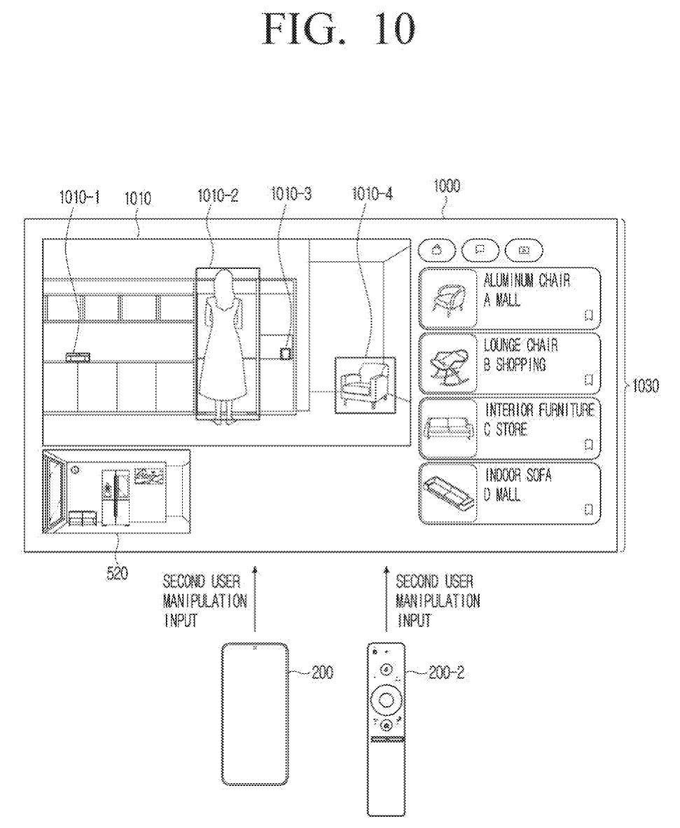

For example, the at least one processor 130 may obtain at least one user interface (UI) including each of the at least one object obtained, and obtain at least one search result corresponding to the object that is the search target upon receiving a second user manipulation input. This will be described in detail later with reference to FIG. 10.

Here, the second user manipulation input may correspond to an input for selecting the search target among at least one object. Here, the second user manipulation input may correspond to a signal provided by the external electronic apparatus, similar to the first user manipulation input. For example, the second user manipulation input may correspond to an input (e.g., a directional key input or touch input) that is input to the external electronic apparatus. Here, the directional key input or the touch input may correspond to each of multiple directions such as up, down, left, and right. This will be described in detail later with reference to FIG. 10.

The at least one processor 130 may obtain at least one search result corresponding to the object that is the search target upon receiving a third user manipulation input from the external electronic apparatus.

Here, the third user manipulation input may correspond to an input for selecting at least one object included in at least one image of interest as a search target. For example, the third user manipulation input may correspond to a manipulation input corresponding to the touch input that is input to the external electronic apparatus for selecting one of the objects as the search target.

For example, the third user manipulation input may correspond to a signal corresponding to a touch input for forming a trajectory surrounding an object included in an image of interest. Here, the touch input may correspond to a touch input that is input by a user to an external electronic apparatus.

For example, the third user manipulation input may correspond to a remote control signal for forming the trajectory surrounding the object. That is, when the external electronic apparatus is implemented as the remote control equipped with the gyro sensor, the trajectory may be formed based on an inclination and a direction of the remote control.

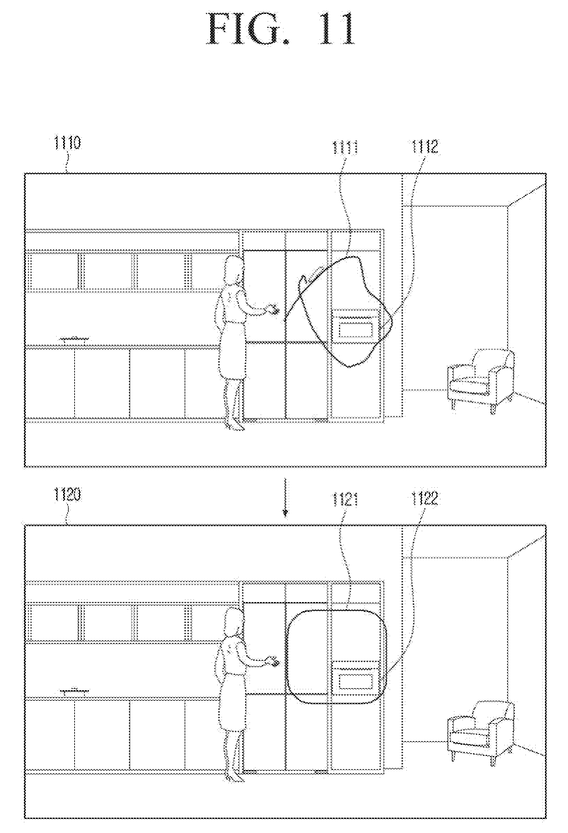

Thereafter, the at least one processor 130 may obtain the trajectory corresponding to the touch input when receiving the third user manipulation input, and may obtain at least one search result corresponding to at least one object included in an area formed by the trajectory among at least one image of interest. This will be described in detail later with reference to FIG. 11.

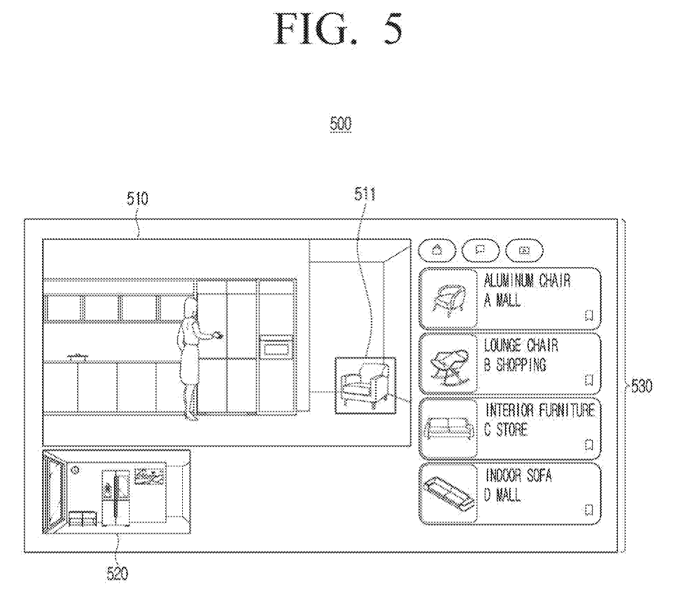

According to one or more embodiments, the multi-view image including at least one image of interest, at least one search result, and content being played may be obtained. Here, the multi-view image will be described in detail in FIGS. 4 and 5, etc.

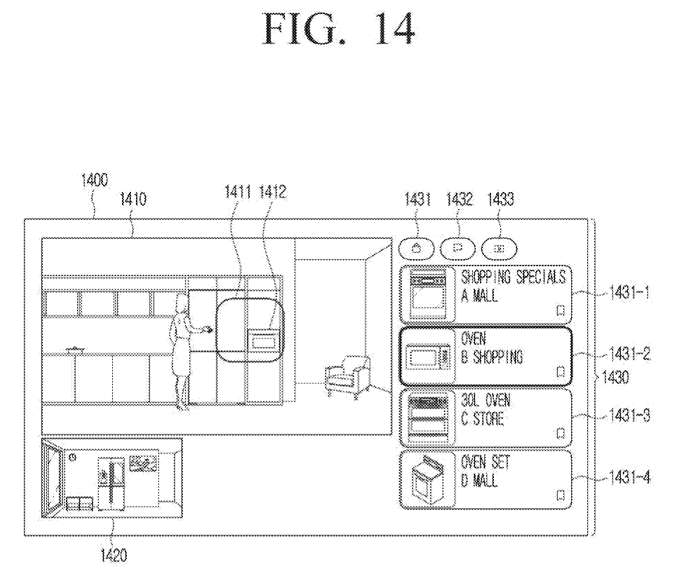

For example, at least one search result classified according to a plurality of information types may be obtained. Here, the plurality of information types may include at least one of a shopping list, a review, and video content. Here, a more specific description of an example of the plurality of information types will be described later in FIG. 14.

For example, at least one search result and personal information may be input to the neural network model, and based on arrangement information obtained, at least one search result may be obtained. Here, the neural network model may correspond to a neural network model trained to output arrangement information of multiple search results based on personal information on the user.

In FIG. 2, the electronic apparatus 100 is illustrated as including only basic components (e.g., memory, processor, communication device), but the electronic apparatus 100 may further include various components in addition to the above-described components. For example, the electronic apparatus 100 may further include a display.

The display is a component for displaying the multi-view image obtained by the electronic apparatus 100, an operation status or notification message of the electronic apparatus 100, a UI screen, etc. The display may be implemented by various types of displays such as a liquid crystal display (LCD), an organic light emitting diode (OLED) display, a plasma display panel (PDP), and the like. A driving circuit, a backlight unit, and the like, that may be implemented in a form such as an amorphous silicon thin film transistor (a-si TFT), a low temperature poly silicon (LTPS) TFT, and an organic TFT (OTFT), may be included in the display.

The display may be implemented as a flexible display, a three-dimensional display (3D display), or the like. Alternatively, the display may be implemented as only one or more light-emitting elements.

According to one or more embodiments, the at least one processor 130 may display the multi-view image. For example, the at least one processor 130 may control the display to display an image of interest, at least one search result, and content being played in each of a plurality of partial areas of the multi-view image during a search mode.

Here, the search mode may correspond to an operation mode for searching for at least one object included in at least one image of interest. For example, according to the user manipulation input for using the electronic apparatus 100 in the search mode, the electronic apparatus 100 may operate in the search mode. For example, here, the user manipulation input may correspond to a user input for capturing an image of interest. However, the user manipulation input is not limited thereto.

Thereafter, the at least one processor 130 may control the display to display the content being played in an entire area when a fourth user manipulation input is received. Here, the fourth user manipulation input may correspond to an input for switching from the search mode to a play mode.

For example, the fourth user manipulation input may correspond to a signal requesting 'go back', 'cancel', etc. Here, 'go back' or 'cancel' may be displayed as a UI, etc., on an external electronic apparatus, etc. However, the disclosure is not limited thereto.

Thereafter, the communication device 120 may be controlled such that at least one of at least one search result and at least one image of interest is provided to the external electronic apparatus. That is, when the search mode is terminated according to the fourth user manipulation input, the obtained search result, etc., may be provided to the external electronic apparatus.

Accordingly, the electronic apparatus 100 may re-enlarge content previously played again and display the enlarged content on the entire area of the display. In addition, the external electronic apparatus may display the search result provided from the electronic apparatus 100 such that the user may view the search result via the external electronic apparatus. Accordingly, the user may not only continue with an existing viewing experience through the entire screen of the electronic apparatus 100, but also have a search experience using the electronic apparatus 100 through the external electronic apparatus (e.g., the user terminal apparatus, etc.).

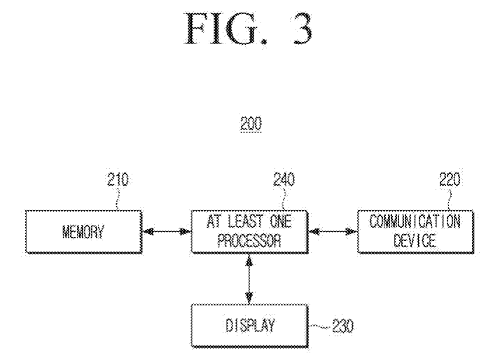

FIG. 3 is a block diagram for describing a configuration of the external electronic apparatus according to one or more embodiments of the disclosure.

Referring to FIG. 3, an external electronic apparatus 200 may include a memory 210, a communication device 220, a display 230, and at least one processor 240.

The memory 210 may store at least one instruction related to an operation of the external electronic apparatus 200.

The memory 210 may be electrically connected to the at least one processor 240, similar to the memory 110 of the electronic apparatus 100, and may store data related to various embodiments of the disclosure. Here, the memory 210 may be implemented in various forms such as a ROM and a RAM.

The memory 210 may store at least one instruction for generating a control signal corresponding to a user operation input to the external electronic apparatus 200. The memory 210 may store at least one instruction for providing the generated control signal to the electronic apparatus 100, etc.

The memory 210 may store at least one instruction for receiving a search result from the electronic apparatus 100 and displaying the at least one instruction on the external electronic apparatus 200. However, the disclosure is not limited thereto.

The communication device 220 may perform communication with the electronic apparatus 100 to transmit and receive data.

The communication device 220 may transmit and receive the above-described control signal and search result by performing communication with the electronic apparatus 100. Here, the communication device 220 may communicate with the communication device 120 of the electronic apparatus 100 in a wired or wireless manner according to various methods. For example, the communication device 220 may include a WiFi module, a Bluetooth module, an infrared communication module, a wireless communication module, and the like.

The external electronic apparatus 200 may display video data through the display 230. Here, the display 230 may be implemented similarly to the display of the electronic apparatus 100, but the display 230 may be implemented as a touch screen combined with a touch sensor.

Here, the touch screen may perform a function of displaying video data of the external electronic apparatus 200 and receiving a user's touch manipulation. For example, the external electronic apparatus 200 may display a UI for selecting an object included in an image of interest through the touch screen. In this case, the user may touch the UI displayed on the touch screen of the external electronic apparatus 200 with a finger to select one object included in the image of interest.

Accordingly, the external electronic apparatus 200 may convert a touch signal into a manipulation signal for manipulating the electronic apparatus 100 and provide the manipulation signal to the electronic apparatus 100 through the communication device 220. However, the function of the touch screen is not limited to the above-described example, and the external electronic apparatus 200 may display a UI for selecting one of multiple directions (up, down, left, right, etc.) through the touch screen, and may also receive a touch manipulation for selecting one direction.

The display 230 may display information on an operating status of the electronic apparatus 100 and/or an operating status of the external electronic apparatus 200 through the display 230. For example, the information on the operating status of the external electronic apparatus 200 may correspond to an on/off status, a current channel, a remaining battery level, etc. of the external electronic apparatus 200. The information on the operation status of the electronic apparatus 200 may correspond to information on a channel currently broadcast by the electronic apparatus 100, a volume, a content title, whether the electronic apparatus 100 is in the search mode and/or the play mode, etc.

For example, when the external electronic apparatus 200 is implemented as the remote control, the display 230 may display the information on the on/off status of the remote control, the current channel, the remaining battery level information, the volume of the electronic apparatus 100, the content title, and/or the operation mode of the electronic apparatus 100.

The at least one processor 240 may perform the overall control operation of the external electronic apparatus 200.

The at least one processor 240 may be implemented as various types of processors (e.g., digital signal processor, microprocessor, CPU, MCU, MPU, etc.), similar to the at least one processor 130 provided in the electronic apparatus 100. In addition, although FIG. 3 illustrates that the external electronic apparatus 200 includes only one processor, the external electronic apparatus 200 may include multiple processors when implemented.

For example, the at least one processor 240 may convert a user manipulation signal input through the display 230, etc., to a control signal for controlling the electronic apparatus 100.

For example, the at least one processor 240 may detect a change in current, pressure, etc., according to a user's touch input and convert them into numerical data. The at least one processor 240 may generate a control signal based on the converted data and provide the generated control signal to the electronic apparatus 100 through the communication device 220.

The operation of the at least one processor 240 is not necessarily limited thereto, and the electronic apparatus 100 may perform various control operations to obtain the multi-view image.

The external electronic apparatus 200 may further include at least one button for receiving a user manipulation input in addition to the above-described configuration. For example, the external electronic apparatus 200 may receive various types of the user manipulation input through at least one button.

In addition, the external electronic apparatus 200 may further include a microphone for receiving a user voice input. The microphone may receive user voice and transmit the received user voice to the at least one processor 240. Subsequently, the at least one processor 240 may input the received user voice into a voice recognition model to perform voice recognition. For example, the at least one processor 240 may perform speech to text (STT) on the user voice to perform the voice recognition on the user voice.

For example, the external electronic apparatus 200 may receive a manipulation input for selecting at least one object by the user or a manipulation input for obtaining an image of interest, through the microphone. That is, the user may utter a voice such as 'I'm curious about a second object from the left' or 'Capture a screen now', and the microphone may receive a user's uttered voice and provide the user’s uttered voice to the at least one processor 240.

Thereafter, the at least one processor 240 may perform the voice recognition on the provided voice. The at least one processor 240 may perform a function appropriate to the intention based on the result (e.g., text, etc.) of the voice recognition. For example, the at least one processor 240 may provide a control signal to the electronic apparatus 100 through the communication device 220. Here, the control signal may correspond to a signal for obtaining a search result for the second object from the left among the objects displayed on the screen.

Although FIG. 3 illustrates the external electronic apparatus 200 including various components, some of the components illustrated may be omitted. In addition, although not illustrated, other components may be further included.

Hereinafter, the operation of the electronic apparatus 100 and the external electronic apparatus 200 acquiring the multi-view image by the various components described above will be specifically described.

FIG. 4 is a block diagram for describing the operation of the electronic apparatus according to one or more embodiments of the disclosure.

Referring to FIG. 4, an operation 400 of the electronic apparatus 100 acquiring a multi-view image 431 is illustrated step by step. The operation of each step may be performed by one processor, and each module may be performed by another processor (or another apparatus).

In an embodiment, the electronic apparatus 100 may acquire an image of interest 411 from playback content 410, select one object 420 included in the image of interest, acquire a search result 430 corresponding to the selected object, and acquire a multi-view image 431 including a plurality of partial areas 431-1, 431-2, and 431-3.

Here, the playback content 410 may correspond to video content that the electronic apparatus 100 is currently playing. For example, the electronic apparatus 100 may play content provided through a TV channel, such as live content, or the electronic apparatus 100 may play content provided through an OTT service. However, the disclosure is not limited thereto.

The electronic apparatus 100 may obtain at least one image of interest 411 from the content 410 being played. Here, the content 410 being played may include multiple images. Here, the multiple images may mean a plurality frames included in the video. Here, the multiple frames or the multiple images may each be called scenes, or screens, but are not limited thereto.

The electronic apparatus 100 may obtain one of the multiple images as the image of interest 411. The image of interest 411 may correspond to a scene captured by the user or an image that the user is estimated to be interested in. Here, the estimated image may correspond to an image estimated by the neural network model based on the user's profile information, etc., as described above.

Here, an operation of capturing a scene of interest of the user may be performed through the external electronic apparatus 200 or may be performed through a manipulation interface (e.g., a button, a microphone, etc.) separately provided in the electronic apparatus 100. However, the disclosure is not limited thereto. An example of the operation of obtaining the image of interest 411 will be described in detail below with reference to FIG. 6.

The electronic apparatus 100 may select one object 420 of at least one object included in the obtained image of interest 411. Here, the object may mean an object included in a specific image. However, here, the object may mean not only a specific object included in the specific image, but also a color, pattern, text, etc., of the specific object included in the specific image.

Here, the electronic apparatus 100 may select one object according to the received user manipulation input. Alternatively, even if the user does not perform an operation to select an object through the external electronic apparatus 200, the electronic apparatus 100 may select an object that the user is estimated to be interested in. Here, the estimated object may be obtained by the neural network model. Here, the neural network model may correspond to a model trained to obtain the object that the user is estimated to be interested in based on the user's profile information, etc.

The electronic apparatus 100 may provide a search function, and in this case, the selected object 420 may correspond to a search target. That is, the electronic apparatus 100 may select an object selected from among various objects included in the image of interest 411 as the search target.

The electronic apparatus 100 may acquire the search result for the object that is the search target. Here, the search result may correspond to a search result that includes one or more pieces of content. Here, the search result may include product information, shopping information, a user review, product advertisement, similar products, etc., for the selected object 420.

Here, the electronic apparatus 100 may obtain information on the search target from an application, website, etc., that provides a video or shopping service. The electronic apparatus 100 may classify the obtained information according to a type of the information and obtain search results according to the classification. This will be described in detail later with reference to FIG. 14.

The information on the search target obtained by the electronic apparatus 100 may include the product advertisement. The electronic apparatus 100 may obtain a search result by receiving advertisement content provided by an external advertisement platform. Here, the advertisement platform may be an online system or a server apparatus that enables an advertiser to create and manage advertisement and distribute and analyze advertisement. The advertisement platform may be used to create and distribute various forms of digital advertisements.

The electronic apparatus 100 may obtain the multi-view image 431 including the playback content 410, the image of interest 411, and the search result 430. An entire area of the multi-view image 431 may include the plurality of partial areas 431-1, 431-2, and 431-3.

Here, the electronic apparatus 100 may obtain the multi-view image by placing the playback content 410 in the first partial area 431-1, placing the image of interest 411 in the second partial area 431-2, and placing the search result in the third partial area 431-3.

In this case, the first partial area 431-1 where the playback content 410 is placed may correspond to an area where the video, which is the playback content 410, is displayed. Here, the display of the video may mean that the multiple images included in the video are displayed sequentially over time.

The positions where each partial area 431-1, 431-2, and 431-3 is displayed in FIG. 4 may not represent display positions of each partial area 431-1, 431-2, and 431-3 in the actual multi-view image 431. That is, each partial area 431-1, 431-2, and 431-3 may be arranged at any position in the entire area of the multi-view image 431.

FIG. 5 is a diagram for describing the multi-view according to one or more embodiments of the disclosure.

Referring to FIG. 5, the electronic apparatus 100 may obtain a multi-view image 500 including an image of interest 510, a content playback image 520, and a search result 530. Here, the image of interest 510 may include an object 511. Here, the image of interest 510 is illustrated as including one object 511, but may also include various objects such as objects, colors, and patterns included in the image of interest 510.

Here, the content playback image 520 may mean a screen on which the content is being played. For example, the electronic apparatus 100 may sequentially display the multiple images included in the content over time. In this case, the multi-view image 500 may include the image currently displayed by the electronic apparatus 100 as the content playback image 520. Accordingly, in the area where the content playback image 520 is located among the multi-view images 500, the video may be played and displayed as time passes.

The multi-view image 500 may include the image of interest 510 located at upper left, the search result 530 located at right, and the content playback image 520 located at lower left. However, the disclosure is not limited thereto, and each image (e.g., image of interest, search result, and content playback image) may be positioned at various other locations.

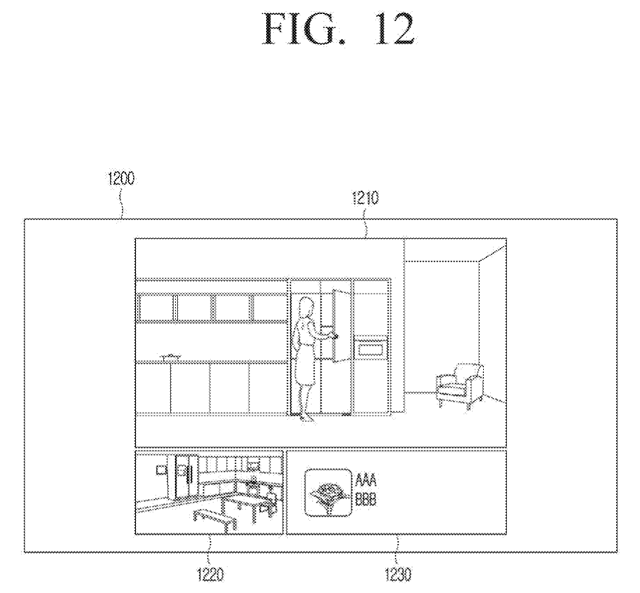

In addition to the content playback image and search result described above, the multi-view image 500 may include various types of related content related to the current content being played. For example, information on background music (BGM) included in the playback content and related images related to the playback content may be included in the multi-view image 500. This will be described in detail later with reference to FIG. 12.

Accordingly, the electronic apparatus 100 may provide a screen through the multi-view image including a screen where content is played even while the user is using the search function, thereby preventing the viewer's viewing experience from being interrupted. In this way, the electronic apparatus 100 may integrate search experience and continuous content viewing experience and provide the integrated experience.

Hereinafter, a specific operation of the electronic apparatus 100 acquiring the image of interest in order to provide the search function to the user will be described.

FIG. 6 is a diagram for describing the operation of capturing the image of interest according to one or more embodiments of the disclosure.

Referring to FIG. 6, a user 10 may capture an image of interest 600 through the external electronic apparatus 200.

Here, the user 10 may input a capture manipulation for capturing a screen of content, and accordingly, the external electronic apparatus 200 may provide a capture signal (or capture command) to the electronic apparatus 100.

Here, the capture may mean a process of saving a specific screen of content being played as an image. Here, the capture manipulation may correspond to a manipulation in which a user selects a frame of a video being played using a specific button or UI and saves the selected frame as an image.

For example, the user 10 may select a desired scene by pressing a screen capture button during video playback, and the scene may be saved as an image file on the electronic apparatus.

The electronic apparatus 100 may play the content and output a first image 610 and a second image 620. Here, the first image 610 may correspond to the image 610 displayed by the electronic apparatus 100 at a time when the user 10 inputs the capture manipulation through the external electronic apparatus 200. Here, the second image 620 may correspond to the image displayed by the electronic apparatus 100 at a time when the electronic apparatus 100 receives the capture signal through the external electronic apparatus 200.

In this case, the image that the user 10 wants to capture may correspond to the first image. However, the image obtained by the electronic apparatus 100 according to the user manipulation input may correspond to the second image 620. In this case, the second image 620 may correspond to a different image from the first image 610.

However, a plurality of objects (refrigerator, person, oven, sofa, etc.) included in the first image 610 and a plurality of objects (refrigerator, person, oven, sofa, etc.) included in the second image 620 may be the same. In this case, even if the second image 620 is different from the first image 610, the electronic apparatus 100 may acquire the second image 620 as the image of interest that matches an intention of the user 10 who inputs the capture manipulation.

However, when the plurality of objects included in the second image 620 and the plurality of objects included in the first image are different, the second image 620 may not be an image that the user 10 wants to capture. This will be described in detail later.

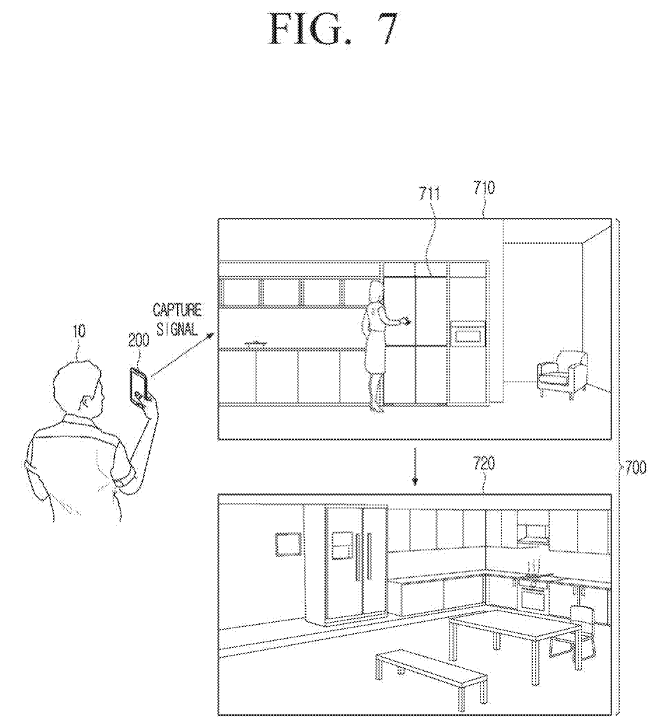

FIG. 7 is a diagram for describing the operation of capturing the image of interest according to one or more embodiments of the disclosure.

Referring to FIG. 7, the electronic apparatus 100 may play content and sequentially output each of the multiple images over time. Accordingly, the electronic apparatus 100 may output a first image 710 and then output a second image 720 according to a change in the scene. That is, the first image 710 and the second image 720 may correspond to different images.

Specifically, the plurality of objects (refrigerator, one person, oven, sofa, etc.) included in the first image 710 and the plurality of objects (refrigerator, table, chair, light, etc.) included in the second image 720 may be different. In this case, the second image 620 may correspond to an image that does not correspond to the intention of the user 10 inputting the capture manipulation.

For example, the user 10 may view the refrigerator 711 included in the first image 710 of the content being played, and input the capture manipulation to search for information on the refrigerator 711. The external electronic apparatus 200 that receives the capture manipulation may provide a corresponding capture signal to the electronic apparatus 100.

In this case, the electronic apparatus 100 may output the second image 720, which is the changed scene, while playing the content. The electronic apparatus 100 may capture and acquire the second image 720 at the time when the capture signal is received by the electronic apparatus 100. Here, the second image 720 may correspond to an image that does not include the refrigerator 711 that the user wants to search for.

Here, the second image 720 may correspond to an image that does not match the intention of the user inputting the capture manipulation. The operation of the electronic apparatus 100 to solve this will be specifically described in the following section.

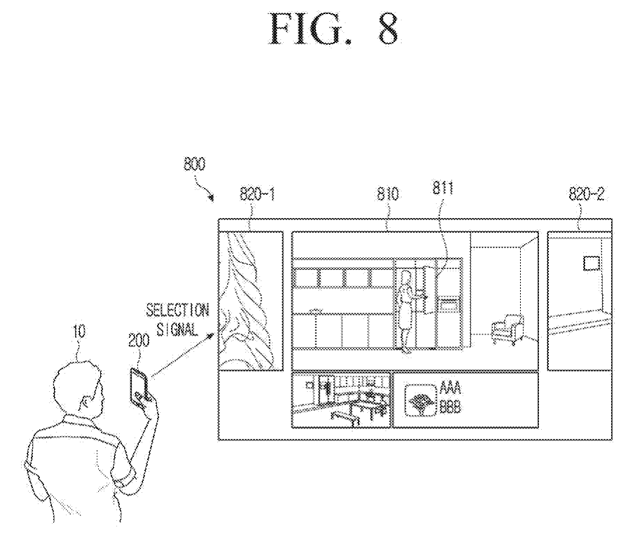

FIG. 8 is a diagram for describing the operation of capturing the image of interest according to one or more embodiments of the disclosure.

According to FIG. 8, the electronic apparatus 100 may acquire a multi-view image 800. Here, the multi-view image 800 may include a plurality of captured images 810, 820-1, and 820-2. The plurality of captured images 810, 820-1, and 820-2 may correspond to a first image 820-1, a second image 810, and a third image 820-2, respectively.

The electronic apparatus 100 may play content and acquire the plurality of captured images 810, 820-1, and 820-2 described above based on the change in the object. Here, the electronic apparatus 100 may recognize an object included in each image of the content through the neural network model. Here, the neural network model may correspond to a model trained to recognize at least one object included in an input image.

For example, the electronic apparatus 100 may acquire the capture image based on the change in the object included in each image while sequentially playing the multiple images included in the content over time. That is, the electronic apparatus 100 may acquire the current image as the capture image when an object included in a current image among the multiple images is different from an object included in a previous image.

In an embodiment, when a new object not included in a previous image is included in the current image, the current image may be obtained as the capture image. Alternatively, when at least one of the objects included in the previous image is not included in the current image, the current image may be obtained as the capture image.

The electronic apparatus 100 may acquire the plurality of capture images 810, 820-1, and 820-2 by repeating the above-described process. Accordingly, the plurality of capture images may correspond to images obtained whenever a scene changes. Here, the change in the scene may mean that the configuration of the object included in each image changes as described above.

The electronic apparatus 100 may obtain the multi-view image 800 including the plurality of captured images 810, 820-1, and 820-2, and may select one of the plurality of captured images 810, 820-1, and 820-2.

For example, the user 10 may input a manipulation for selecting one of the plurality of captured images 810, 820-1, and 820-2 to the external electronic apparatus 200. Alternatively, the user 10 may input a manipulation for sequentially switching and displaying each of the plurality of captured images 810, 820-1, and 820-2. Here, the manipulation may correspond to a manipulation for selecting a left, right, up, or down direction.

For example, the user 10 may input a manipulation for selecting the second image 810 including a refrigerator among the multiple captured images 810, 820-1, and 820-2. The external electronic apparatus 200 may provide a selection signal corresponding to the manipulation input to the electronic apparatus 100, and the electronic apparatus 100 may select and acquire the second image 810 as the image of interest based on the selection signal.

Accordingly, a problem that may occur due to a difference between the time when the user 10 inputs the capture manipulation and the time when the electronic apparatus 100 acquires the captured image may be solved. That is, the electronic apparatus 100 may acquire and store the multiple captured images 810, 820-1, and 820-2 in advance based on the change in the scene, and may allow the user to select one of the multiple images 810, 820-1, and 820-2, thereby effectively acquiring the image of interest desired by the user 10.

FIG. 9 is a diagram for describing an image of interest including an object of interest according to one or more embodiments of the disclosure.

Referring to FIG. 9, the electronic apparatus 100 may obtain multiple images of interest 910-1, 910-2, and 910-3 from among multiple images 910 included in content 900. Here, the multiple images 910 may mean multiple frames included in the video.

Here, the electronic apparatus 100 may obtain the multiple images of interest 910-1, 910-2, and 910-3 based on the information on the object of interest. Here, the information on the object of interest may correspond to the information included in the user manipulation input. Here, the user manipulation input may correspond to an input for the user to set the object of interest.

Here, the object of interest may correspond to an object set in advance by the user. The user may set the object of interest to be automatically recognized and captured when the object of interest is included in a specific scene. Here, the object of interest may correspond to an object or person appearing in a specific scene. The object of interest may be set for the purpose of detecting a subject preferred or interested by the user in real time and recording the scene.

For example, the user may set the refrigerator illustrated in FIG. 9 as an object of interest 913. The user may input a manipulation for setting the object of interest 913 to the external electronic apparatus 200, and the external electronic apparatus 200 may provide the user manipulation input for setting the refrigerator as the object of interest 913 to the electronic apparatus 100.

Thereafter, the electronic apparatus 100 may sequentially input the multiple images 910 included in the content 900 to the neural network model to recognize at least one object included in each of the multiple images 910. Here, the neural network model may correspond to the neural network model for object recognition as described in FIG. 8.

A user may further specify the type of item, such as a "two-door refrigerator". In this case, the electronic apparatus 100 may search for a 'two-door refrigerator' for each scene through the neural network model and capture the current scene when the refrigerator exists in the current scene.

The electronic apparatus 100 may identify multiple images (frames) that include a refrigerator, which is the object of interest 913, among the multiple images 910, and acquire the identified multiple images as multiple images of interest 910-1, 910-2, and 910-3. The user may select one of the multiple images of interest 910-1, 910-2, and 910-3 and select the object of interest included in the selected image as the search target. However, the disclosure is not limited thereto, and the electronic apparatus 100 may acquire the multi-view image including the search result for the object of interest 913 without the user inputting a selection manipulation to select one of the multiple images of interest.

Accordingly, the user may input information on the object of interest in advance into the electronic apparatus 100, and the electronic apparatus 100 may automatically capture a scene including the set object of interest without a user having to manually input a manipulation to capture a scene in which the object of interest appears during a process of viewing content. Accordingly, the user's content viewing experience may be uninterrupted, and the process for acquiring search results may be simplified, thereby increasing convenience in use.

The electronic apparatus 100 may obtain the image of interest in various ways as described above, and may search for the object included in the image of interest to obtain the search result. This will be described in detail in the following section.

FIG. 10 is a diagram for describing a selectable object according to one or more embodiments of the disclosure.

Referring to FIG. 10, the electronic apparatus 100 may obtain a multi-view image 1000 including an image of interest 1010, a content playback image 1020, and a search result 1030.

Here, the image of interest 1010 may include a plurality of UIs 1010-1, 1010-2, 1010-3, and 1010-4 that include each object included in the image of interest 1010. Here, each of the plurality of UIs may correspond to a rectangular shape as illustrated in FIG. 10, but is not limited thereto, and may correspond to various shapes such as a circle or an oval.

Here, the plurality of UIs 1010-1, 1010-2, 1010-3, and 1010-4 may include a first UI 1010-1, a second UI 1010-2, a third UI 1010-3, and a fourth UI 1010-4, respectively. Here, the first to fourth UIs 1010-1, 1010-2, 1010-3, and 1010-4 may each include different objects included in the image of interest 1010.

For example, the electronic apparatus 100 may recognize a plurality of objects included in the image of interest 1010 through the neural network model for object recognition described above. The electronic apparatus 100 may obtain a plurality of UIs 1010-1, 1010-2, 1010-3, and 1010-4 respectively including the recognized plurality of objects. Here, the plurality of UIs 1010-1, 1010-2, 1010-3, and 1010-4 obtained may have different positions and sizes depending on positions of each recognized object.

The user may input a manipulation for selecting the search target through the external electronic apparatus 200. The external electronic apparatus 200 may provide a second user manipulation input for selecting a search target to the electronic apparatus 100.

For example, the user may select a sofa located at far right among the objects recognized by the electronic apparatus 100 through the neural network model among the images of interest 1010 as the search target. The user may input an operation for selecting the sofa through the external electronic apparatus 200, and the external electronic apparatus 200 may provide the second user manipulation input for selecting the sofa as a search target to the electronic apparatus 100.

Thereafter, the electronic apparatus 100 may select the fourth UI 1010-4. In this case, the selected fourth UI 1010-4 may be displayed separately from the first UI 1010-1, the second UI 1010-2, and the third UI 1010-3. Accordingly, the search result for the object (sofa) corresponding to the fourth UI 1010-4 may be obtained and displayed on the multi-view image 1000.

The image of interest 1010 on which the plurality of UIs 1010-1, 1010-2, 1010-3, and 1010-4 are displayed may be displayed through the display of the electronic apparatus 100. However, the disclosure is not limited thereto, and the image of interest 1010 on which the plurality of UIs 1010-1, 1010-2, 1010-3, and 1010-4 are displayed may be displayed through the display of the external electronic apparatus 200. In this case, the user may select one of the plurality of UIs 1010-1, 1010-2, 1010-3, and 1010-4 displayed on the external electronic apparatus 200.

When the user changes and selects another UI among the plurality of UIs 1010-1, 1010-2, 1010-3, and 1010-4, the search result for the object included in the selected another UI may be obtained. Accordingly, the user may select one of the plurality of UIs 1010-1, 1010-2, 1010-3, and 1010-4 as the search target and receive the desired search result through the multi-view image 1000.

The user may select the search target through the UI obtained in advance as above, or select the search target by selecting an area included in the image of interest. This will be described in detail later with reference to FIG. 11.

FIG. 11 is a diagram for describing a trajectory according to one or more embodiments of the disclosure.

Referring to FIG. 11, a first image of interest 1110 and a second image of interest 1120 are illustrated. Here, a trajectory 1111 including an object 1112 is illustrated in the first image of interest 1110, and a UI 1121 including a search target 1122 is illustrated in the second image of interest 1120.

A user may input a manipulation for selecting a search target among a plurality of objects included in the image of interest 1110 through the external electronic apparatus 200. Here, the manipulation may correspond to a touch input using a user's finger or a touch manipulation using a touch pen. However, the disclosure is not limited thereto, and the manipulation may correspond to, for example, a manipulation using a remote control button.

Accordingly, the external electronic apparatus may provide a third user manipulation input corresponding to the user manipulation to the electronic apparatus 100.

When the external electronic apparatus is implemented as a remote control equipped with a gyro sensor, the third user manipulation input may correspond to an input based on an angle, an inclination, and/or a direction of the remote control.

The electronic apparatus 100 may obtain a trajectory corresponding to the third user manipulation input and obtain the first image of interest 1110 including the trajectory. Here, the trajectory corresponding to the third user manipulation input may correspond to a shape having the same shape as the trajectory formed on the external electronic apparatus 200 according to the touch input. Here, the shape having the same shape may correspond to a shape having the same shape as the trajectory formed on the external electronic apparatus but a different size (or ratio).

For example, the user may input a manipulation for selecting an oven 1112 through the external electronic apparatus 200. Accordingly, the electronic apparatus 100 may obtain the trajectory 1111 from the first image of interest 1110. The electronic apparatus 100 may recognize the oven 1112 included in the trajectory 1111. Here, the electronic apparatus 100 may recognize the oven 1112 through the neural network model for object recognition.

The trajectory 1112 may be in various forms that may be used to recognize the search target. For example, as illustrated in FIG. 11, the trajectory 1111 may be a closed curve in the first image of interest 1110. In this case, the electronic apparatus 100 may recognize at least one object, such as the oven 1112, within the closed curve.

The trajectory 1111 may be in a form of a diagonal line, a grid line, or a curve (a curve that is not a closed curve) that indicates a certain area of the first image of interest 1110. In this case, the electronic apparatus 100 may recognize at least one object included in the area indicated by the diagonal line, the grid, or the curve.

When the electronic apparatus 100 identifies that at least one object is included in the trajectory 1111 or in the area occupied by the trajectory 1111, the electronic apparatus 100 may obtain the UI 1121 including an object. Here, the electronic apparatus 100 may obtain the second image of interest 1120 including the UI 1121. Here, the UI 1121 may be implemented as a regular shape, unlike the trajectory 1111 in the first image of interest 1110.

For example, the electronic apparatus 100 may obtain the square UI 1121 including the oven, which is a recognized object. However, the disclosure is not limited thereto, and the UI 1121 may be implemented as various regular shapes including the recognized object. Here, a regular shape may mean a shape with a mathematically clearly defined regular shape, such as a triangle, a square, or a circle.

Through this, the user may easily recognize that the searchable object exists in the trajectory 1111 formed by the user manipulation through the second image of interest 1120.

The electronic apparatus 100 may identify the object corresponding to the trajectory 1111 formed in various forms as the search target. The electronic apparatus 100 may obtain the search result corresponding to the search target.

Thereafter, when the user inputs a manipulation for forming another trajectory through the external electronic apparatus, the electronic apparatus 100 may obtain a search result corresponding to an object included in another trajectory.

The search result obtained in this way may include one or more categories, which will be described in detail in FIG. 14.

FIG. 12 is a diagram for describing related content according to one or more embodiments of the disclosure.

Referring to FIG. 12, a multi-view image 1200 may include an image of interest 1210, a content playback image 1220, and a related content image 1230.

Here, the related content image 1230 may correspond to an image related to the current content being played.

For example, when the electronic apparatus 100 plays a refrigerator advertisement image, the electronic apparatus 100 may display the advertisement image as the content playback image 1220. In this case, the electronic apparatus 100 may extract background music of an advertisement image and obtain information on the background music. In this case, the electronic apparatus 100 may extract audio data of the advertisement image being played. In addition, the electronic apparatus 100 may obtain background music information by comparing the extracted audio data with audio data stored in a database stored in a memory, or by comparing the extracted audio data with a database stored in a server or cloud.

The electronic apparatus 100 may display information on the obtained music as the related content image 1230. Here, the information on the background music may include, for example, a title of the extracted background music, information on album video, and information on an artist. However, the disclosure is not limited thereto.

Accordingly, the electronic apparatus 100 may provide a user with related content such as the background music information from the content such as the advertisement video being played. Accordingly, the electronic apparatus 100 may receive various types of additional content related to the content being played itself in addition to the search results for the object of the current scene. In addition, the electronic apparatus 100 may increase user convenience by providing this function without operating a separate user terminal apparatus.

An embodiment in which the electronic apparatus 100 acquires related content from the content being played and acquires the multi-view image 1200 including information on the content has been described as an example. However, the electronic apparatus 100 may acquire content related to an object corresponding to the corresponding area based on the user manipulation such as selecting a certain area of the image of interest, and acquire the multi-view image including the acquired content related to the object.

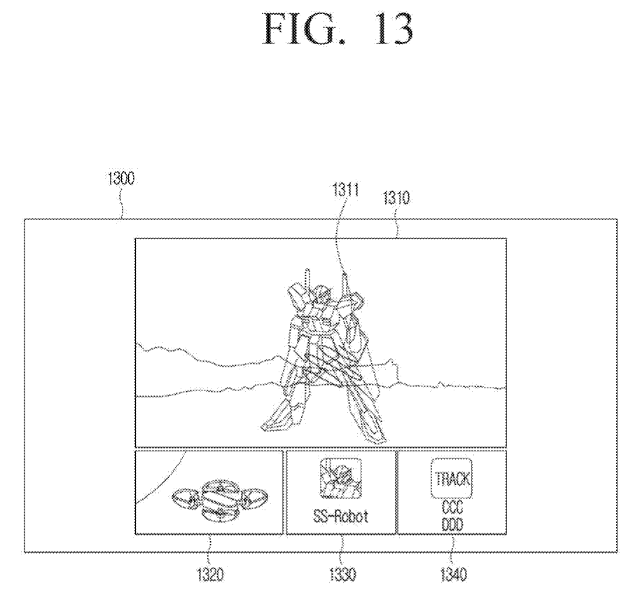

FIG. 13 is a diagram for describing the related content according to one or more embodiments of the disclosure.

Referring to FIG. 13, a multi-view image 1300 may include an image of interest 1310, a content playback image 1320, and related content images 1330 and 1340. Here, the image of interest 1310 may include a curved trajectory 1311.

For example, while the user watches content displayed in the content playback image 1320, the user may input a manipulation for forming the trajectory in the image of interest 1310 through the external electronic apparatus 100. Here, the manipulation may correspond to the touch manipulation described above. However, the disclosure is not limited thereto.

The external electronic apparatus may convert a touch signal into a manipulation signal for operating the electronic apparatus 100 and provide the touch signal to the electronic apparatus 100. Here, the manipulation signal may correspond to a signal of the same type as the third user manipulation input described above.

The electronic apparatus 100 may obtain the image of interest 1310 including the trajectory 1311 based on a manipulation signal. In this case, the electronic apparatus 100 may obtain the related content according to the area formed by the trajectory 1311.

For example, as illustrated in FIG. 13, the image of interest 1310 may include an object such as a robot. When the electronic apparatus 100 forms the trajectory 1311 according to the user manipulation input, the electronic apparatus 100 may recognize that an object such as a robot is included in the area formed by the trajectory 1311. Here, the electronic apparatus 100 may recognize the robot according to the neural network model for object recognition described above.

Accordingly, the electronic apparatus 100 may identify content related to the robot among the content that the electronic apparatus 100 may provide. For example, when the electronic apparatus 100 is connected to the external apparatus that provides game content, such as a game console (e.g., XboxTM, PlayStationTM), the game console may identify a game related to a robot among the game content that may be provided. The electronic apparatus 100 may obtain a representative icon (Icon) of the recognized game as a related content image 1330.

Here, the representative icon may correspond to a UI for executing the game. The user may select the corresponding UI and input a manipulation for executing the game through the electronic apparatus 100. Accordingly, the electronic apparatus 100 may execute the game through the game console connected to the electronic apparatus 100.

However, the related content provided by the electronic apparatus 100 is not limited to games, and the electronic apparatus 100 may identify various related content such as the video content and the audio content related to the robot recognized by using the neural network model.

The electronic apparatus 100 may extract background music from the content being played, similar to the example described in FIG. 12, and provide information on the background music as a related content image 1340.

Accordingly, the electronic apparatus 100 may recognize at least one object included in the image of interest 1310, identify content related to the recognized object, and obtain a related content image 1330 related thereto. That is, by selecting one of the objects included in the image of interest 1310, the user may receive not only the search result for the selected object but also various other content such as games that may be executed through the electronic apparatus 100.

FIG. 14 is a diagram for describing a search result according to one or more embodiments of the disclosure.

Referring to FIG. 14, a multi-view image 1400 may include an image of interest 1410, a content playback image 1420, and a search result image 1430.

The image of interest 1410 may include a search target object 1412 and a UI 1411 including the search target object 1412.

The search result image 1430 may include a plurality of information types 1431, 1432, and 1433, and among the plurality of information types, a shopping list 1431 may include at least one search result 1431-1 to 1431-4.

Here, the plurality of information types may include at least one of the shopping list 1431, a review 1432, and a video content 1433. Here, the shopping list 1431 may include a plurality of search results 1431-1 to 1431-4 corresponding to each of a plurality of websites.

For example, a user may input a manipulation for selecting an oven, which is one of the objects 1412 included in the image of interest 1410. This manipulation may be input through the external electronic apparatus. Since the operation of the electronic apparatus 100 selecting one object as a search target has been specifically described in FIG. 11, a duplicate description will be omitted.

The electronic apparatus 100 may obtain the search result for the search target. The electronic apparatus 100 may obtain information on the search target as a search result from an application, a website, etc., that provides a video or a shopping service. The electronic apparatus 100 may classify the obtained information by type and obtain the search results. Here, the type may correspond to an information type corresponding to each search result.

In an embodiment, the electronic apparatus 100 may obtain the shopping list 1431 corresponding to the search target from the website or the application. Here, each of the plurality of search results included in the shopping list 1431 may correspond to a website link where the product being the search target may be purchased. The user may move to the corresponding website or application execution screen by performing a manipulation (click, etc.) for selecting the link. In this case, each of the plurality of search results may include not only the website link but also an advertisement image of the product being the search target.

The electronic apparatus 100 may obtain the review 1432 corresponding to the search target from the website or the application. Here, each of the plurality of search results included in the review 1432 may correspond to the website link where the review may be checked. Each of the plurality of search results included in the review 1432 may include an experience or an opinion written by a consumer after using the product.

The electronic apparatus 100 may obtain the video content 1433 corresponding to the search target from the website or the application. Here, each of the plurality of search results corresponding to the type of the video content 1433 may include a video of the product being the search result. Here, each of the plurality of search results may correspond not only to the video itself, but also to a website link for playing the video, a thumbnail image of each video, etc.

Referring to FIG. 14, the plurality of information types 1431, 1432, and 1433 may include the shopping list 1431, the review 1432, and the video content 1433. However, this is only an example, and at least one of these information types may be omitted depending on the search result.

The information types 1431, 1432, and 1433 of the search results obtained by the electronic apparatus 100 have been described as examples, but this is only an example, and the electronic apparatus 100 may obtain search results that may be classified into various other information types in addition to or alternatively to the above-described plurality of information types 1431, 1432, and 1433.

Each search result in the search result image 1430 may be displayed according to a preset order. That is, in the embodiment of FIG. 14, the plurality of information types 1431, 1432, and 1433 may be arranged in the order of the shopping list 1431, the review 1432, and the video content 1433. In this case, the multiple search results 1431-1 to 1431-4 included in the shopping list 1431 may be arranged in one of various orders, such as latest, accuracy, and popularity.

Here, the order in which the plurality of information types 1431, 1432, and 1433 are displayed and the order in which each search result 1431-1 to 1431-4 is displayed may be set by the user. However, the disclosure is not limited thereto, and the electronic apparatus 100 may automatically arrange the order of the search results to obtain the search result image 1430.

For example, the electronic apparatus 100 may obtain the search result image 1430 based on the user's personal information, etc. In this case, the search result image 1430 may include a plurality of information types and multiple search results arranged by the electronic apparatus 100.

In an embodiment, the electronic apparatus 100 may obtain the search result image 1430 using the neural network model. Here, the neural network model may correspond to a model trained to output arrangement information of multiple search results based on personal information on the user. The electronic apparatus 100 may obtain arrangement information by inputting search results and personal information obtained into the neural network model.

Here, the user's personal information may include at least one of the user's profile information (age, gender, viewing history, etc.) and viewing characteristics (preferred genre, main viewing time zone, etc.). In other words, the electronic apparatus 100 may obtain arrangement information estimated to be preferred by the user by inputting the personal information into the neural network model.

For example, when the user mainly views shopping content, the electronic apparatus 100 may obtain the search result image 1430 by first arranging the shopping list 1431 among the plurality of information types 1431, 1432, and 1433, for example, arranging the shopping list 1431 at the far left in the multi-view image 1400 as shown in FIG. 14.

In this case, when the user frequently purchases products from a specific website, the search result image 1430 may be obtained by arranging the shopping content of the website at the topmost in the multi-view image 1400 based on a purchase history of the user. Alternatively, the electronic apparatus 100 may obtain the search result image 1430 by arranging a website with a high usage rate in the user's age group and gender at the topmost in the multi-view image 1400.

Accordingly, even if the user does not set the order of search results in advance, the electronic apparatus 100 may provide a search experience that is suitable for the user's personal characteristics and has high expected satisfaction by the user by displaying a search result screen in a manner such that the search results that the user is likely to prefer are displayed first (or prominently displayed).

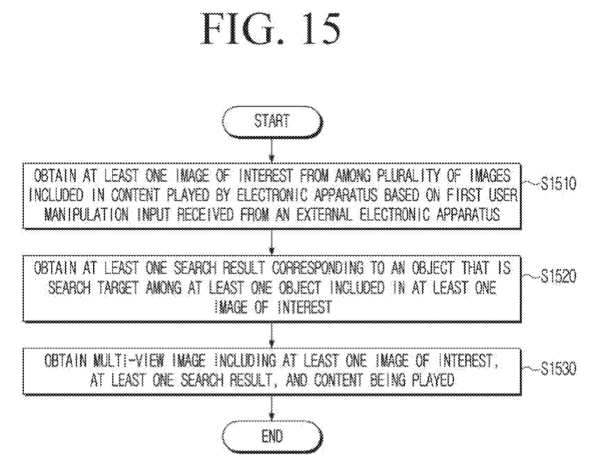

FIG. 15 is a flowchart for describing a control method of an electronic apparatus according to one or more embodiments of the disclosure.

The electronic apparatus 100 may obtain at least one image of interest from among a plurality of images included in content played by the electronic apparatus based on a first user manipulation input received from an external electronic apparatus (S1510).

According to one or more embodiments, the first user manipulation input is an input for capturing an image included in the content, and the electronic apparatus 100 may obtain the at least one image of interest includes capturing the at least one image of interest from among the plurality of images based on the first user manipulation input, to obtain the at least one image of interest.

According to one or more embodiments, the first user manipulation input includes information on at least one object of interest, and the electronic apparatus 100 may obtain the at least one image of interest including the at least one object of interest among the plurality of images based on the information.

Next, the electronic apparatus 100 may obtain at least one search result corresponding to an object that is a search target among at least one object included in the at least one image of interest (S1520).

According to one or more embodiments, the electronic apparatus 100 may obtain at least one object included in the at least one image of interest by inputting the at least one image of interest to a neural network model.

The electronic apparatus 100 may obtain at least one search result corresponding to an object that is the search target among the obtained at least one object.

The neural network model may be a model trained to recognize an object included in an input image.

Next, the electronic apparatus 100 may obtain a multi-view image including the at least one image of interest, the at least one search result, and the content being played (S1530).

According to an embodiment, the electronic apparatus 100 may obtain at least one search result classified according to a plurality of information types. Here, a plurality of information types may include at least one of a shopping list, a review, and video content.

According to one or more embodiments, the electronic apparatus 100 may display the image of interest, at least one search result, and content being played in each of the plurality of partial regions of the multi-view image during the search mode.

Thereafter, the electronic apparatus 100 may control the display to display the content being played in the entire region when the fourth user manipulation input is received. In addition, the electronic apparatus 100 may provide at least one of the at least one search result and at least one image of interest to an external electronic apparatus.

Through this, the electronic apparatus 100 may provide a screen where content is played while providing a search function to the user, thereby preventing the existing viewing experience from being interrupted. In addition, the electronic apparatus 100 may provide a search experience suitable for the individual characteristics of the user by using various neural network models, such as a neural network model for object recognition, and may also prevent the existing search experience from being interrupted by providing the search result to the user terminal apparatus even when the search operation is terminated. Accordingly, the electronic apparatus 100 may not only provide continuous viewing experience and search experience, but also harmoniously integrate the viewing experience and the search experience.

In FIG. 15, the order of all steps is mapped for convenience of description, but it is obvious that the order of steps, etc., that are not related to the order or can be performed in parallel is not necessarily limited to the order.

The methods according to at least some of various embodiments of the disclosure may be implemented in a form of application that may be installed in the existing electronic apparatus.

In addition, the above-described methods according to at least some of various embodiments of the disclosure may be implemented only by software upgrade and/or hardware upgrade of the existing electronic apparatus.

Further, the methods according to at least some of various embodiments of the disclosure described above may also be performed through an embedded server included in the electronic apparatus or an external server of at least one of the electronic apparatuses.

According to an embodiment of the disclosure, various embodiments described above may be implemented by software including instructions stored in a machine-readable storage medium (for example, a computer-readable storage medium). A machine may be an apparatus that invokes the stored instruction from the storage medium and may be operated depending on the invoked instruction, and may include the electronic apparatus (for example, the electronic apparatus 100) according to the disclosed embodiments. In the case in which a command is executed by the processor, the processor may directly perform a function corresponding to the command or other components may perform the function corresponding to the command under a control of the processor. The command may include codes created or executed by a compiler or an interpreter. The machine-readable storage medium may be provided in a form of a non-transitory storage medium. Here, the 'non-transitory storage medium' means that the storage medium is a tangible apparatus, and does not include a signal (for example, electromagnetic waves), and the term does not distinguish between the case where data is stored semi-permanently on a storage medium and the case where data is temporarily stored thereon. For example, the “non-transitory storage medium” may include a buffer in which data is temporarily stored. According to an example embodiment, the methods according to the diverse example embodiments disclosed in the present document may be included and provided in a computer program product. The computer program product may be traded as a product between a seller and a purchaser. The computer program product may be distributed in a form of a machine-readable storage medium (for example, compact disc read only memory (CD-ROM)), or may be distributed (for example, download or upload) through an application store (for example, Play StoreTM) or may be directly distributed (for example, download or upload) between two user apparatuses (for example, smartphones) online. In a case of the online distribution, at least some of the computer program products (for example, downloadable app) may be at least temporarily stored in a machine-readable storage medium such as a memory of a server of a manufacturer, a server of an application store, or a relay server or be temporarily created.

Various embodiments of the disclosure may be implemented by software including instructions stored in a machine-readable storage medium (for example, a computer-readable storage medium). A machine may be an apparatus that invokes the stored instruction from the storage medium and may be operated depending on the invoked instruction, and may include the electronic apparatus (for example, the electronic apparatus 100) according to the disclosed embodiments.

In the case in which the above-described command is executed by the processor, the processor may directly perform a function corresponding to the command or other components may perform the function corresponding to the command under a control of the processor. The command may include codes created or executed by a compiler or an interpreter.

Although the example embodiments of the disclosure have been illustrated and described hereinabove, the disclosure is not limited to the above-described specific example embodiments, but may be variously modified by those skilled in the art to which the disclosure pertains without departing from the gist of the disclosure as disclosed in the accompanying claims. These modifications should also be understood to fall within the scope and spirit of the disclosure.

What is claimed is:

1. An electronic apparatus, comprising:
a memory configured to store at least one instruction;
a communication device configured to perform communication with an external electronic apparatus; and
at least one processor configured to be connected to the memory and the communication device to control the electronic apparatus,
wherein the at least one processor is configured to:
obtain at least one image of interest from among a plurality of images included in a content played by the electronic apparatus, based on a first user manipulation input received from the external electronic apparatus;
obtain at least one search result corresponding to an object that is a search target among at least one object included in the at least one image of interest; and
obtain a multi-view image including the at least one image of interest, the at least one search result, and the content being played.

2. The electronic apparatus as claimed in claim 1, wherein the first user manipulation input is an input for capturing an image included in the content, and the at least one processor is configured to capture the at least one image of interest from among the plurality of images based on the first user manipulation input, to obtain the at least one image of interest.

3. The electronic apparatus as claimed in claim 1, wherein the first user manipulation input includes information on at least one object of interest, and the at least one processor is configured to obtain the at least one image of interest including the at least one object of interest among the plurality of images based on the information.

4. The electronic apparatus as claimed in claim 1, wherein the memory is configured to store a neural network model trained to recognize an object included in an input image, and
wherein the at least one processor is configured to:
input the at least one image of interest to the neural network model to obtain at least one object included in the at least one image of interest; and
obtain at least one search result corresponding to an object that is the search target among the obtained at least one object.

5. The electronic apparatus as claimed in claim 4, wherein the at least one processor is configured to:
obtain at least one user interface (UI) including each of the obtained at least one object;
obtain at least one search result corresponding to the object that is the search target upon receiving a second user manipulation input for selecting the search target among the at obtained least one object; and
obtain the multi-view image including at least one image of interest on which the at least one UI is displayed, the at least one search result, and the content being played.

6. The electronic apparatus as claimed in claim 1, wherein the at least one processor is configured to obtain at least one search result corresponding to the object that is the search target upon receiving a third user manipulation input for selecting, as the search target, at least one object included in the at least one image of interest from the external electronic apparatus.

7. The electronic apparatus as claimed in claim 6, wherein the third user manipulation input corresponds to a touch input that is input to the external electronic apparatus for selecting the at least one object as the search target, and
wherein the at least one processor is configured to:
obtain a trajectory corresponding to the touch input upon receiving the third user manipulation input; and
obtain at least one search result corresponding to at least one object included in an area defined by the trajectory among the at least one image of interest.

8. The electronic apparatus as claimed in claim 1, wherein the at least one processor is configured to obtain the at least one search result classified according to a plurality of information types, and
wherein the plurality of information types include at least one of a shopping list, a review, and a video content.

9. The electronic apparatus as claimed in claim 8, wherein the memory is configured to store a neural network model trained to output arrangement information of a plurality of search results based on personal information on a user of the electronic apparatus, and
wherein the at least one processor is configured to obtain the at least one search result based on the arrangement information acquired by inputting the at least one search result and the personal information to the neural network model.

10. The electronic apparatus as claimed in claim 1, further comprising:
a display,
wherein the at least one processor is configured to:
control the display to display the at least one image of interest, the at least one search result, and the content being played in each of a plurality of partial areas of the multi-view image during a search mode for searching for at least one object included in the at least one image of interest;
control the display to display the content being played in an entire area, based on a fourth user manipulation input for switching from the search mode to a reproduction mode being received; and
control the communication device to provide at least one of the at least one search result and the at least one image of interest to the external electronic apparatus.

11. A control method of an electronic apparatus, comprising:
obtaining at least one image of interest from among a plurality of images included in content played by the electronic apparatus based on a first user manipulation input received from an external electronic apparatus;
obtaining at least one search result corresponding to an object that is a search target among at least one object included in the at least one image of interest; and
obtaining a multi-view image including the at least one image of interest, the at least one search result, and the content being played.

12. The control method as claimed in claim 11, wherein the first user manipulation input is an input for capturing an image included in the content, and the obtaining the at least one image of interest includes capturing the at least one image of interest from among the plurality of images based on the first user manipulation input, to obtain the at least one image of interest.

13. The control method as claimed in claim 11, wherein the first user manipulation input includes information on at least one object of interest, and the obtaining the at least one image of interest includes obtaining the at least one image of interest including the at least one object of interest among the plurality of images based on the information.

14. The control method as claimed in claim 11, wherein the obtaining the at least one search result includes:
obtaining at least one object included in the at least one image of interest by inputting the at least one image of interest to a neural network model; and
obtaining at least one search result corresponding to an object that is the search target among the obtained at least one object, and
wherein the neural network model is a model trained to recognize an object included in an input image.

15. A non-transitory computer-readable recording medium storing a computer command that, when executed by at least one processor of an electronic apparatus, causes the electronic apparatus to perform:
obtaining at least one image of interest from among a plurality of images included in content played by the electronic apparatus based on a first user manipulation input received from an external electronic apparatus;
obtaining at least one search result corresponding to an object that is a search target among at least one object included in the at least one image of interest; and
obtaining a multi-view image including the at least one image of interest, the at least one search result, and the content being played.
